(19) United States
(12) Patent Application Publication
(10) Pub. No.: US 2001/0042650 A1
(43) Pub. Date: Nov. 22, 2001

(54) Passenger vehicle

(75) Inventor: Karel van den Berg, Bleskensgraaf (NL)

Correspondence Address: Penrose Lucas Albright, Esq., MASON, MASON & ALBRIGHT, P.O. Box 2246, Arlington, VA, 22202-0246, US

(73) Assignee: LELY RESEARCH HOLDING A.G., A Swiss Limited Liability Co.

(21) Appl. No.: 09/883,918

(22) Filed: Jun. 20, 2001

Related U.S. Application Data
(63) Continuation of application No. PCT/NL00/00666, filed on Sep. 19, 2000.

(30) Foreign Application Priority Data
Apr. 26, 2001 (WO) 01/28848 A1
Oct. 20, 1999 (NL) 1013354

(51) Int. Cl. B62D 61/00

(52) U.S. Cl. 180/218

(57) ABSTRACT

A passenger vehicle comprises exactly two wheels (1, 2) which are in contact with the ground during travelling of the vehicle, a motor and a passenger space (3). The axes of rotation of the two wheels (1, 2) are situated substantially in one horizontal line or in one vertical plane. Consequently, the vehicle is very compact.

The invention relates to a vehicle according to the preamble of claim 1. Passenger vehicles are generally known in many different designs.

The invention aims at providing a compact and simple passenger vehicle. According to the invention this is achieved by the measures mentioned in the characterizing part of claim 1.

The invention will now be explained in further detail with reference to the accompanying drawings.

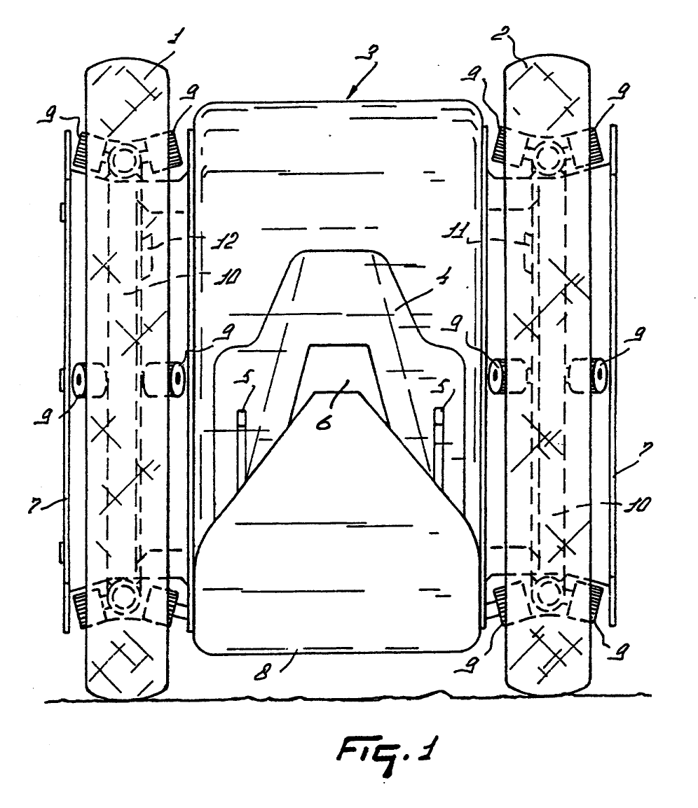

FIG. 1 is a schematic front view of an embodiment of a passenger vehicle according to the invention;

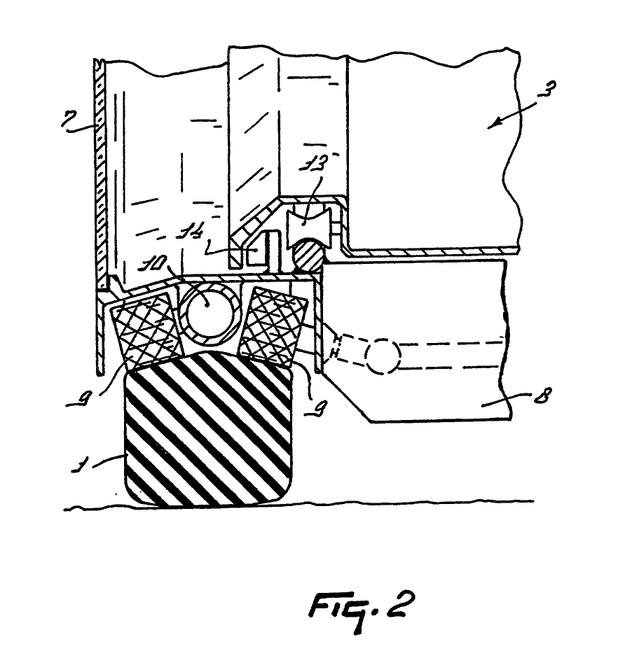

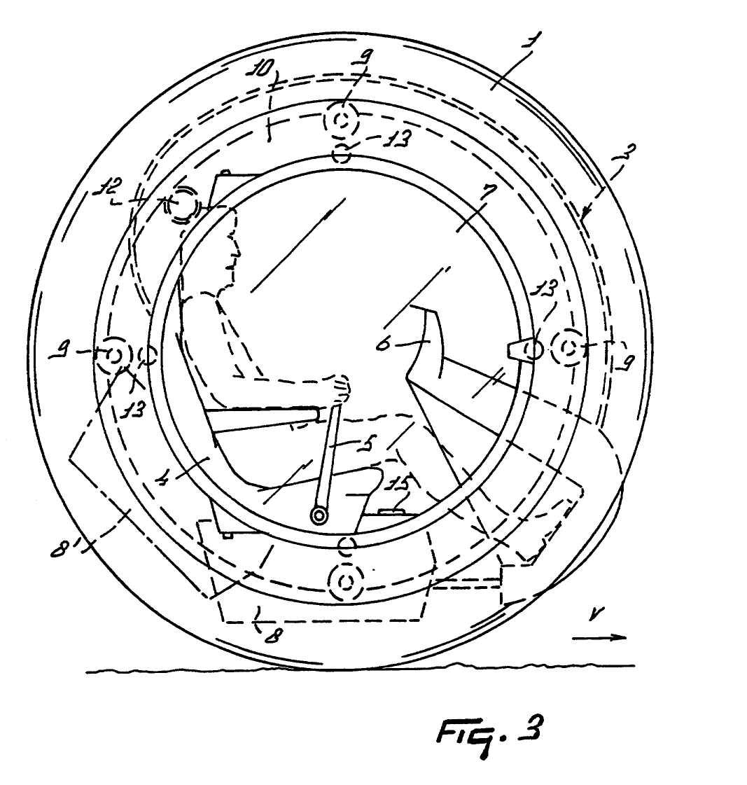

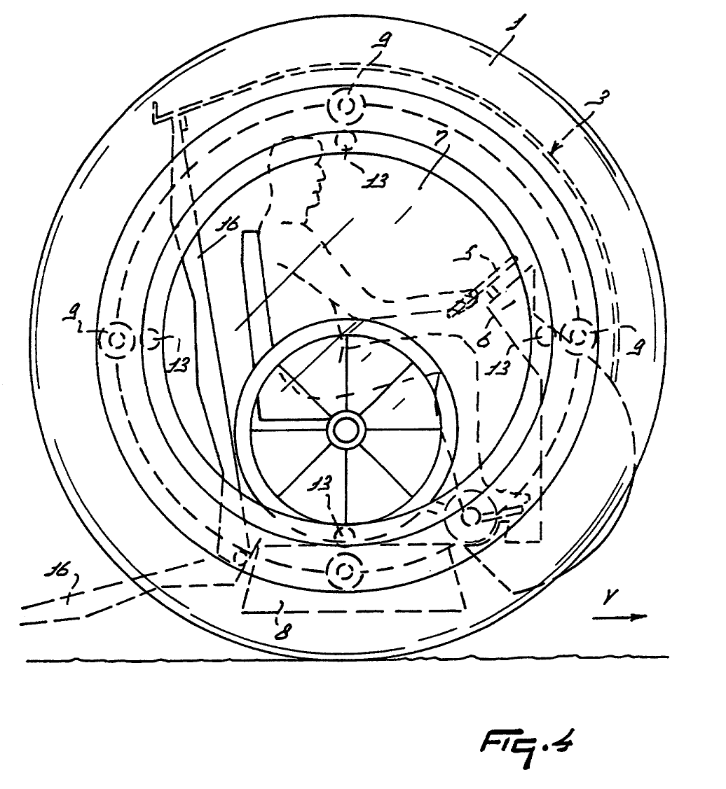

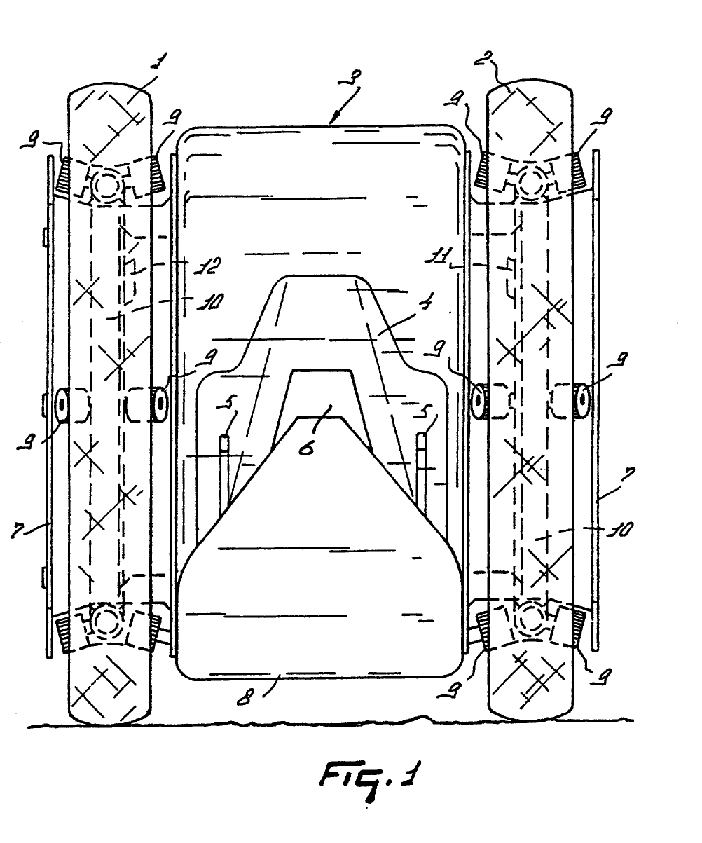

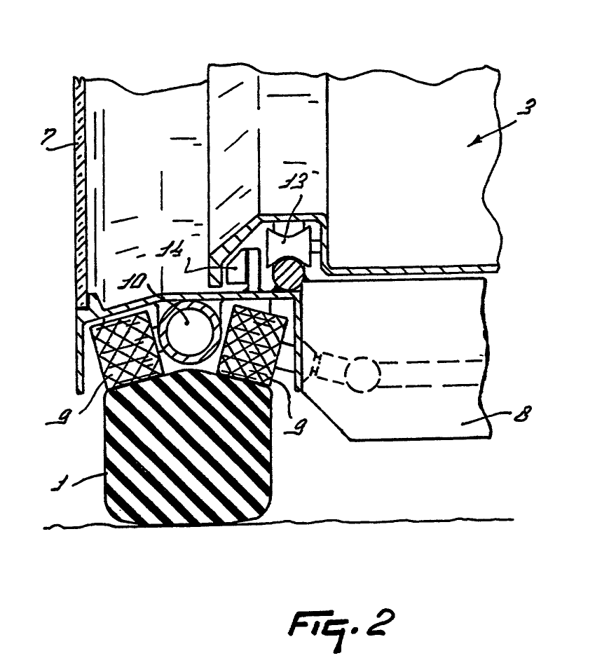

FIG. 2 shows schematically a part of the vehicle depicted in FIG. 1;

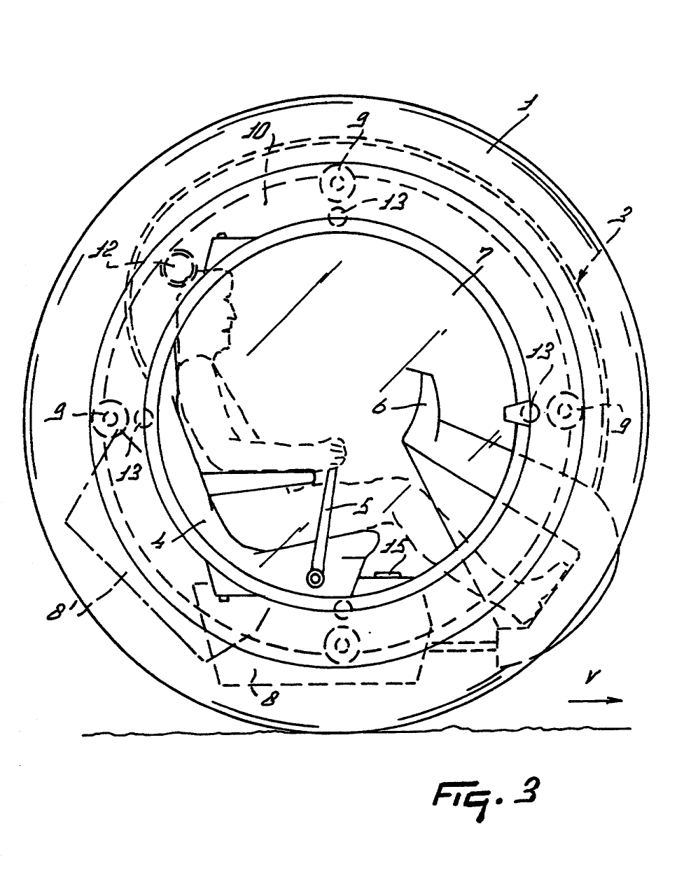

FIG. 3 is a schematic side view of the vehicle shown in FIGS. 1 and 2, and

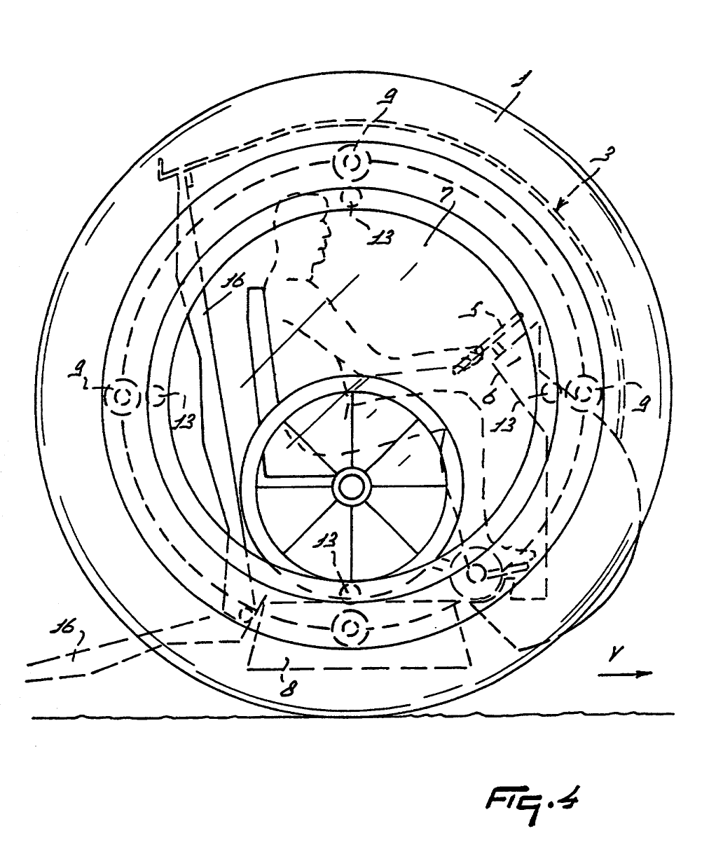

FIG. 4 is a schematic side view of a further embodiment of a vehicle according to the invention.

FIG. 1 is a schematic front view of a first embodiment of a passenger vehicle according to the invention. The vehicle comprises two wheels 1, 2 and a cabin 3 with a seat 4, control devices 5 and an instrument panel 6. The cabin 3 may be a closed one and may be made (at least partially) from a transparent material. Instead of the cabin 3 it is also possible to provide a (partially) open passenger space. The control devices 5 may be designed as a steering wheel or, as depicted, as control levers. For protection purposes the outside of the wheels 1, 2 is provided with cover plates 7.

The vehicle further comprises a (non-shown) motor for its drive. Said motor may be designed as a propeller motor, a jet engine or a linear motor. In the exemplary embodiment the motor is constituted by an electric motor with an energy source such as an accumulator and/or a solar cell. The motor with its accumulator forms, possibly together with an extra weight, a driving weight 8 (see FIG. 2) for the vehicle. Said driving weight 8 may be rigidly connected to the cabin 3, but may also be rotatably bearing-supported loose from the cabin 3, as will be explained hereinafter with reference to the figures.

On the inner side of the wheels 1, 2 the vehicle is provided with a plurality of rollers 9, the lowest one of which on the inner side of each wheel 1, 2 is capable of being driven by the motor. The rollers 9 co-operate with the wheels 1, 2, e.g. due to the fact that the rollers 9 are provided with teeth and the inside of the wheels 1, 2 is provided with a toothing. The rollers 9 are connected to a circular rail 10 which is disposed concentrically with the relevant wheel. When in another embodiment the motor is designed such that air is required and waste products are formed, said rail 10 may also be provided with an inlet 11 and an outlet 12 for the motor. In that case a fuel tank may also serve as a driving weight 8.

With the aid of the driven rollers 9 the driving weight 8 connected thereto is displaced, viz. is rotated about the line forming the imaginary, common axis of rotation of the wheels 1, 2. Consequently, the centre of gravity of the vehicle is displaced in such a manner that the vehicle is set in motion from a standstill. By bringing, by means of the rollers 9, the driving weight 8 into a position in which it is situated in the direction of travel in front of the contact surface of the vehicle with the ground, and by keeping it in said position, it is achieved that the vehicle accelerates. When the vehicle has reached the desired speed, it is possible to rotate the driving weight 8 a little backwards relative to the imaginary axis of rotation, so that it is situated in the direction of travel just in front of the contact surface of the vehicle with the ground, as a result of which the occurring frictional forces can be compensated and the vehicle maintains a constant speed. For the purpose of slowing down the driving weight 8, by rotation about the imaginary axis of rotation, is brought into a position in which it is situated in the direction of travel behind the contact surface of the vehicle with the ground (see also FIG. 3). The vehicle may further be provided with non-shown additional brake means.

For steering the vehicle there is provided a control system which is adapted for adjusting the driving ratio between the wheels 1, 2 by the motor. It is also possible for the motor to drive selectively neither of the two wheels 1, 2, one of the two wheels 1, 2 or both wheels 1, 2. Further the momentary driving direction of the wheels 1, 2 can be set. In this way it is possible to influence the direction of travel of the vehicle.

As shown in FIG. 2, the driving weight 8 is connected to the rollers 9 and the rail or tube 10, so that the driving weight 8 is bearing-supported so as to be rotatable about the imaginary, common axis of rotation relative to the wheels 1, 2. The cabin 3 is rotatably bearing-supported relative to the driving weight 8 by means of rollers 13. Consequently, the cabin 3 is bearing-supported so as to be rotatable about the common, imaginary, horizontal axis of rotation, not only relative to the driving weight 8 but also to the wheels 1, 2. By means of a brake 14 the cabin 3 is temporarily fixedly connected to the driving weight 8. As soon as the driving weight 8 is displaced in such a manner that moving along of the cabin 3 is undesired, the brake 14 is detached and, as will be set out hereinafter, the cabin 3 will be displaced relative to the driving weight 8.

FIG. 3 is a schematic side view of the vehicle shown in FIGS. 1 and 2. The driving weight is again indicated by the reference numeral 8, in this situation in a position of rest in which it is located substantially over the contact surface of the vehicle with the ground. By the reference numeral 8′ the same driving weight is indicated, but now in a more backward position in which the vehicle slows down.

The orientation of the cabin 3 relative to the horizon (or, if desired, relative to the ground) can be adjusted by means of a measuring and control system. This system comprises measuring means for determining the current orientation of the cabin 3 relative to the horizon (or, if desired, the ground) and control means for correcting said orientation, if required. The measuring means may e.g. be designed as a spirit level 15, as angle sensors or as acceleration sensors. The control means may comprise a (non-shown) extra motor for rotating the cabin 3 relative to the driving weight 8 about the imaginary axis of rotation through a desired angle.

The vehicle is not only suitable for transporting persons by land, but may also be used as a vessel, in the latter situation the running surface of the wheels 1, 2 being provided with blades or paddles. These blades or paddles may be designed as elements which are capable of sliding in and out or being folded in and out, the vehicle thus becoming an amphibious vehicle which is employable both by land and by water.

For the purpose of enhancing security, the lateral sides of the vehicle may further be provided with a (non-shown) roller bar.

FIG. 4 is a schematic side view of a further embodiment of a vehicle according to the invention. In this situation the vehicle is suitable for transporting an invalid in a wheelchair. To that end at the back of the vehicle there is disposed a door 16 which is capable of being folded down (indicated in its folded down position by the reference numeral 16′). Via the folded down door 16′ the wheelchair can easily be moved into the cabin 3 of the vehicle.

1. A passenger vehicle comprising exactly two rotatable elements (1, 2) which are in contact with the ground during travelling of the vehicle, a motor and a passenger space (3), characterized in that the axes of rotation of the two rotatable elements (1, 2) are situated substantially in one horizontal line or in one vertical plane.

2. A vehicle as claimed in claim 1, characterized in that the motor is constituted by a propeller motor or a jet engine.

3. A vehicle as claimed in claim 1, characterized in that the motor is constituted by a linear motor.

4. A vehicle as claimed in any one of claims 1 to 3, characterized in that the vehicle is provided with a driving weight (8) which is displaceable by means of the motor for influencing the position of the centre of gravity of the vehicle.

5. A vehicle as claimed in any one of claims 1 to 4, characterized in that the motor is adapted for driving drive rollers (9) that co-operate with the rotatable elements (1, 2).

6. A vehicle as claimed in any one of claims 1 to 5, characterized in that the passenger space (3) is connected to the rotatable elements (1, 2) so as to be rotatable about an imaginary, horizontal axis connecting the centres of the two rotatable elements (1, 2).

7. A vehicle as claimed in any one of claims 1 to 6, characterized in that the vehicle is provided with means ensuring that the passenger space (3) maintains substantially the same orientation relative to the ground or relative to the horizon.

8. A vehicle as claimed in claim 6, characterized in that the means comprise a measuring and control system with measuring means for determining the current orientation of the passenger space (3) relative to the ground or the horizon and control means for correcting said orientation, if required.

9. A vehicle as claimed in any one of claims 4 to 8, characterized in that the axes of rotation of the two rotatable elements (1, 2) are substantially situated in one horizontal line forming an imaginary, common axis of rotation, and the driving weight (8) is connected to the rotatable elements (1, 2) so as to be rotatable about said imaginary axis.

10. A vehicle as claimed in claim 9, characterized in that the motor is adapted for making the driving weight (8) rotate about the common imaginary axis into such a position that the vehicle accelerates, or maintains a constant speed, or slows down.

11. A vehicle as claimed in any one of claims 9 and 10, characterized in that the driving weight (8) is rotatably bearing-supported relative to the rotatable elements (1, 2) and the passenger space (3) is rotatably bearing-supported relative to the driving weight (8).

12. A vehicle as claimed in any one of claims 9 to 11, characterized in that there are provided means for adjusting the orientation of the passenger space (3) relative to the common imaginary axis depending on the orientation of the driving weight (8) relative to the common imaginary axis.

13. A vehicle as claimed in any one of claims 1 to 12, characterized in that the running surface of the wheels (1, 2) is provided with blades or paddles.

14. A vehicle as claimed in claim 13, characterized in that the blades or paddles are designed as elements which are capable of sliding in and out or being folded in and out.

15. A vehicle as claimed in any one of claims 1 to 14, characterized in that the lateral sides of the vehicle are provided with a roller bar.

16. A vehicle as claimed in any one of claims 1 to 15, characterized in that the vehicle is provided with a control system which is adapted for making the motor drive selectively neither of the two rotatable elements (1, 2), one of the two rotatable elements (1, 2) or both rotatable elements (1, 2).

17. A vehicle as claimed in claim 16, characterized in that the control system is adapted for setting the momentary driving ratio between the two rotatable elements (1, 2) when the motor drives the two rotatable elements (1, 2).

18. A vehicle as claimed in any one of claims 16 and 17, characterized in that the control system is adapted for setting the momentary driving direction of the driven rotatable elements (1, 2).

19. A vehicle as claimed in any one of claims 1 to 18, characterized in that the passenger space of the vehicle is provided with a door (16) which is capable of being folded down.
